(19) United States
(12) Patent Application Publication
(10) Pub. No.: US 2018/0374118 A1
(43) Pub. Date: Dec. 27, 2018

(54) PORTABLE EVENT ANALYTICS DEVICE AND METHOD

(71) Applicant: Richard Solner, Austin, TX (US)

(72) Inventor: Richard Solner, Austin, TX (US)

(21) Appl. No.: 16/015,604

(22) Filed: Jun. 22, 2018

Related U.S. Application Data
(63) Continuation of application No. 62/523,648, filed on Jun. 22, 2017.

(51) Int. Cl. G06Q 30/02

(52) U.S. Cl. CPC G06Q 30/0252; G06Q 30/0258; G06Q 30/0267; G06Q 30/0271; G06Q 30/0255

(57) ABSTRACT

The present invention includes a method of generating event data and analytics using a portable computing device comprising offering event participants to sign-in to access to a service, providing the service to event participants that sign-in, gathering data about the event participants that sign-in, analyzing the gathered data about event participants that sign-in, generating offers and presenting such offers to the event participants that sign-in.

This application claims the benefit of U.S. Provisional Patent Application No. 62/523,648, filed on Jun. 22, 2017, which is incorporated by reference in its entirety as if set forth herein.

### FIELD OF THE INVENTION

The present invention is directed to a portable event analytics device and a method for performing event analytics.

### BACKGROUND

The present invention is a self-contained, portable, analytic intelligence system for use at events to provide experiential marketing and consumer data collection that eliminates or reduces infrastructure setup, support, and latent monitoring.

Events that bring substantial numbers of people together at a single location—such as sports events, concerts, music festivals, road shows, conventions, etc.—offer a unique opportunity to connect with participants, include customers and/or other users. Such events often provide a specific context and as a result they bring together a self-selected group of people with certain interests or professions. Effectively connecting with, gathering data from, and understanding the behavior of such a group of people can be extremely valuable.

In order to collect and evaluate data from such events, participants and/or advertisers often create systems to collect data and process data such as through solicitation for participation in surveys, etc. One of the biggest hurdles of event success tracking is the data model definition, sourcing, transfer, manipulation and ingestion of data into a hosted environment while then extracting the extrinsic value of the data itself. Advertisers and participants typically perform many steps, such as system setup, data transfer, data prep, metadata creation, modeling, model interpretation, measure interpretation, merging of information, relevance extraction, significance findings and delivery of results to be used by customers.

### SUMMARY OF THE INVENTION

The present invention includes a method of generating event data and analytics using a portable computing device comprising offering event participants to sign-in to access to a service, providing the service to event participants that sign-in, gathering data about the event participants that sign-in, analyzing the gathered data about event participants that sign-in, generating offers and presenting such offers to the event participants that sign-in.

### BRIEF DESCRIPTION OF THE DRAWINGS

FIG. 1 is a diagram of self-contained, portable, analytic intelligence system in accordance with the present invention.

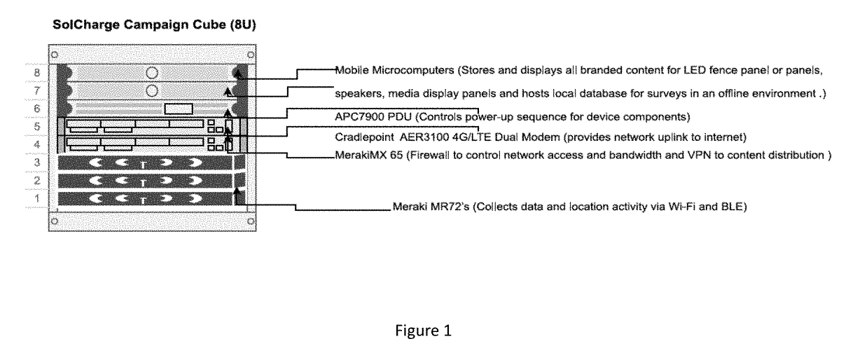

FIG. 2 is a diagram of an image processing architecture and process in accordance with the present invention.

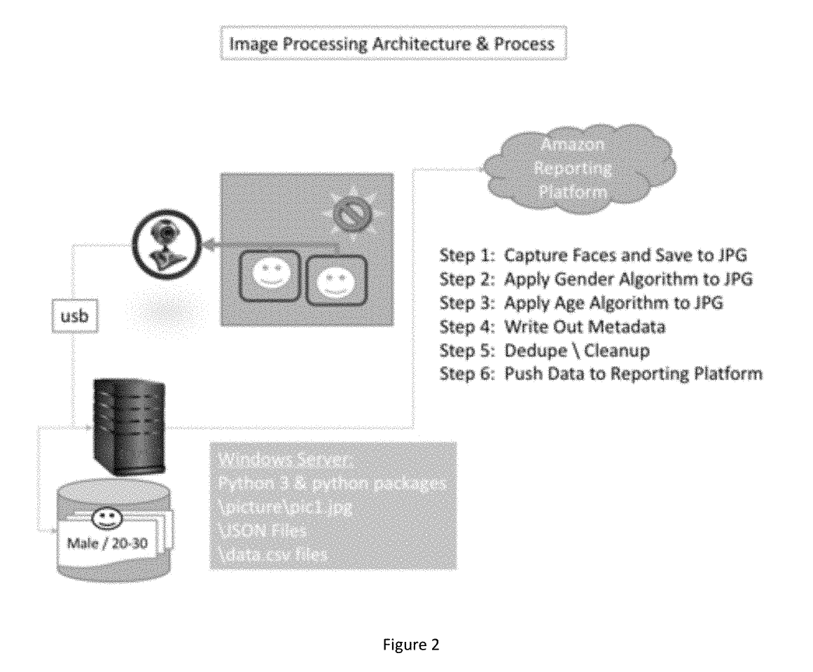

FIG. 3 is a funnel diagram of a prospect intake system in accordance with the present invention.

FIG. 4 is a screen shot of an exemplary report that can be generated in accordance with the present invention.

FIG. 5 is a screen shot of an exemplary report that can be generated in accordance with the present invention.

FIG. 6 is a screen shot of an exemplary report that can be generated in accordance with the present invention.

FIG. 7 is a screen shot of an exemplary report that can be generated in accordance with the present invention.

FIG. 8 is a screen shot of an exemplary report that can be generated in accordance with the present invention.

FIG. 9 is a screen shot of an exemplary report that can be generated in accordance with the present invention.

FIG. 10 is a screen shot of an exemplary report that can be generated in accordance with the present invention.

### DETAILED DESCRIPTION

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

In various exemplary embodiments, the present invention comprises an integrated, portable electronic system that can be set up at an event and may provide a variety of outputs as well as data collection and analytical features. The system may be configured to handle the output of content such as branded digital content (videos, images, social media feeds, etc.) to displays such as an electronic LED fence panel or panels, media display panels with audio output or direct speakers for audio only. Content for display may be stored on the system to avoid the need for internet or other network access, particularly at remote or highly congested sites.

The system may also be configured to collect and analyze data via proprietary analytic algorithms for users and location utilizing the 802.X Wi-Fi and BLE (Bluetooth Low Energy) protocols at any event, including high density events, such as sports events, concerts, music festivals, road shows, etc.

In various exemplary embodiments, data may be collected anonymously without user interaction or with identifiable user details requiring interaction. To collect identifiable information, event users must attach their mobile device to the appropriate Wi-Fi SSID's of the device. Users may sign in using an established service such as Facebook, Google+, or other social media platforms, or provide pertinent identifiable information to a controlled landing page before the system will provide access to services such as branded digital content and the internet or other networks.

In various exemplary embodiments, users may be offered access to a service or promotion to induce them to interact with the system. For example, users may be offered wife access if they provide certain data or responses to the system. Data regarding all of their interactions with the system can then be gathered, including rates of taking certain action such as downloading an application program, etc.

Once users are connected to the system, data may be streamed in real-time to any appropriate device for storage and/or analysis, such as local servers, remote servers, or the cloud. There data can be parsed and processed to deliver real-time event reporting via any appropriate channel such as a mobile app or a client portal.

Exemplary hardware components that may be used in such a system include the following:
1×Gator 8U rolling rack (Case to contain all hardware.)
1×Cradlepoint AER3100 4G/LTE Dual Modem (provides network uplink to internet)
1×Meraki MX 65 (Firewall to control network access and bandwidth and VPN to content distribution)
1×APC 7900 PDU (Controls power-up sequence for device components)
1 or more Meraki MR72's (Collects data and location activity via Wi-Fi and BLE)
2×Mobile Microcomputers. (Stores and displays all branded content for LED fence panel or panels, speakers, media display panels and hosts local database for surveys in an offline environment.)
High-resolution Network Camera with Infrared capabilites

Unlike currently known systems for event data collection, the present invention includes a variety of unique integrated features that enable it to perform the functions described herein, including routers to create mobile hotspots without the need for hardwiring such as with CAT-5 cable. In various exemplary embodiments, data collection can be obtained from event attendee phone signals rather than RFID or other standard techniques. In various exemplary embodiments, the system can also provide location based “beacon” messaging functionality without requiring native software applications or installation of permanent beacons. In addition, cloud based content management may be used so that event personnel that lack significant technical knowledge or training can plug the system in, type in the location to the user interface, and proper location/activation content will download and display.

In various exemplary embodiments, the system may be integrated into a single unit for ease of transport. For example, the system can be integrated in a rolling case that can be shipped to the event, unloaded easily at the site, and set up easily by non-technical personnel on site.

In various exemplary embodiments, the system may include tools to help customers track and ultimately improve their campaign ROI. Data such as event level and attendee level behavioral, social and descriptive data may be used to determine which factors drive the best customer conversion rates. Such event influencers ultimately lower the cost of impressions earned, customers acquired, and/or improve brand-determined ROI metrics while diagnosing post-event success components. For example, the system may automatically process event and participant data from multiple sources, merge that data, add additional performance measures, make predictions or estimations on this data, and deliver the content or findings in an easy to use format.

The platform thus may include, but is not limited to, hardware, software, data preparation, analysis, and the delivery of results in a single, integrated, portable unit. In various exemplary embodiments, the system may be able to visually capture not only the general age of the event attendees but also the gender in an anonymized predictive fashion. This adds additional value to event analysis especially when coupled with the above mentioned data and findings.

In various exemplary embodiments, facial and object recognition capabilities available through an integrated or connected camera or other data gathering device can also be used to anonymously gather, dedupe, and identify true crowd level metrics for an event. The type of data collected may not be used to identify or store individual data but rather to gather an accurate measure of crowd level descriptions such as gender counts, age ranges, general attitudes, behavior of these groups and provide more accurate engagement or dwell metrics. The platform can be also be trained to identify common objects like customer logos, or customer products that come into view of the system if necessary. This additional layer of facial and object recognition data may confirm trends seen in other forms of data collected and/or augment the quality and success of the overall event. The system can also be used to respond to real-time crowd behaviors and occurrences by dynamically adjusting messaging if required by the customer.

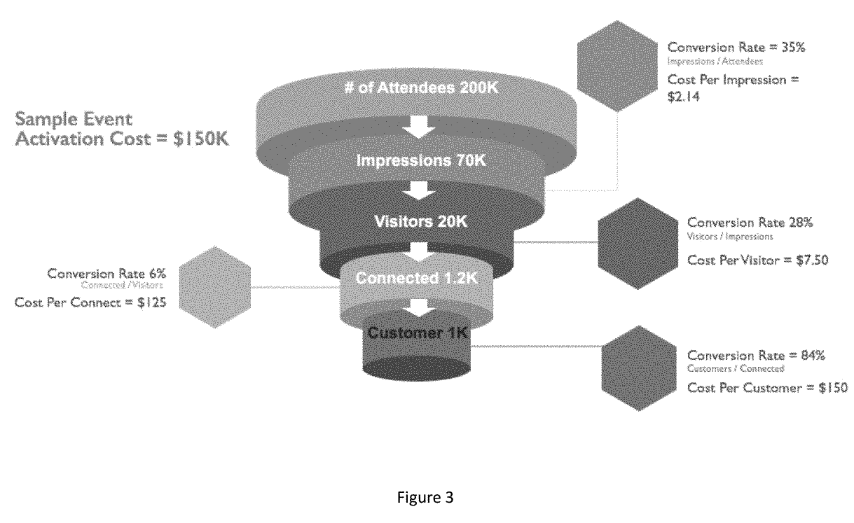

Referring to FIG. 3, a funnel diagram of a prospect intake system is shown in accordance with the proposed solution.

In various exemplary embodiments, the system may be able to create “event-level scoring” (what are good events or types of events to host), and/or “attendee-level scoring” (how valuable are the attendees you are attracting).

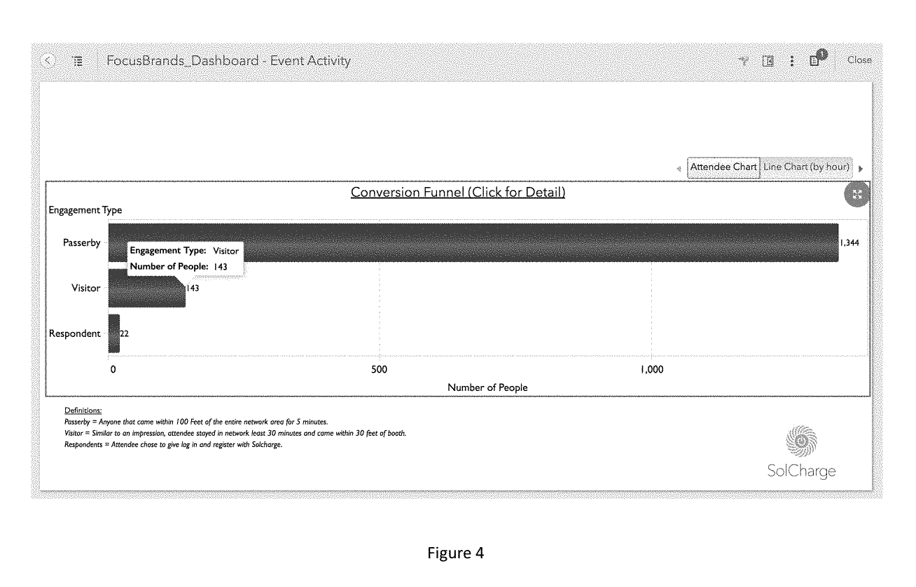

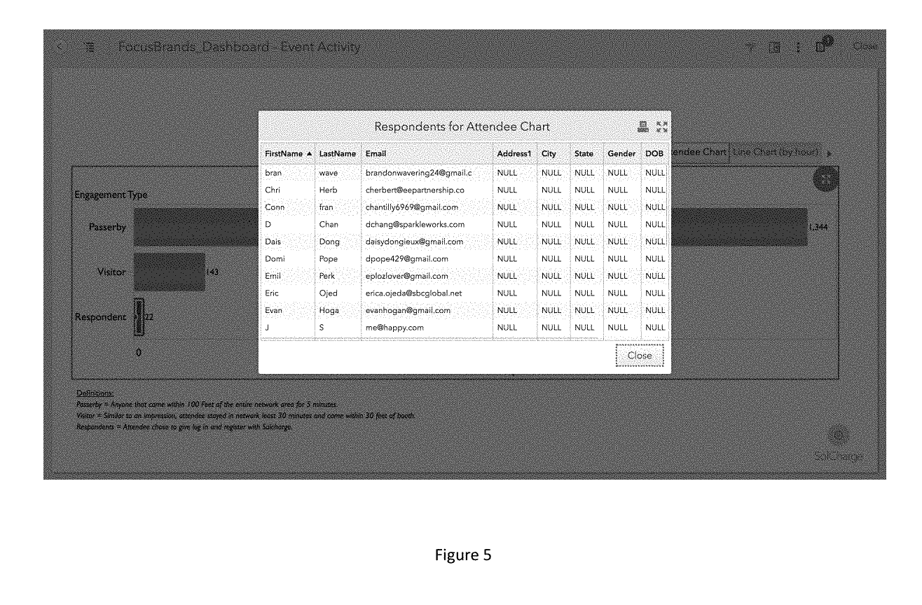

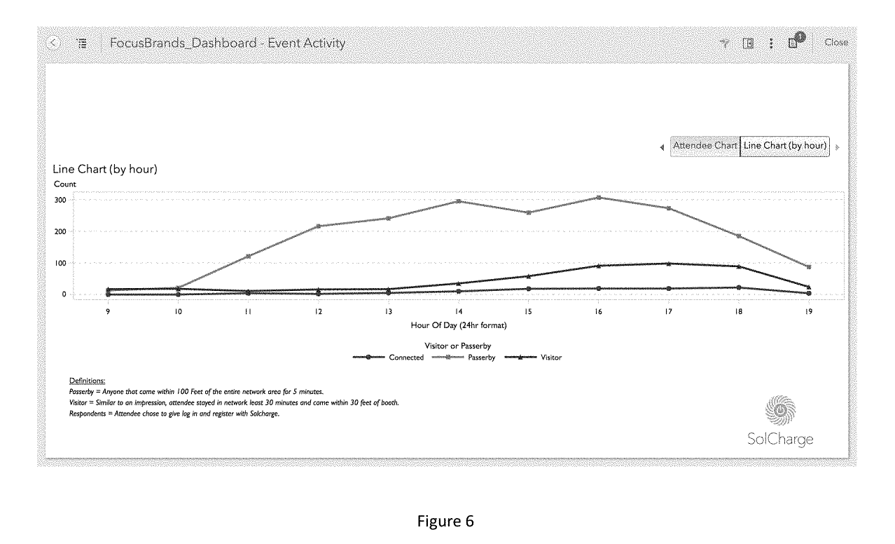

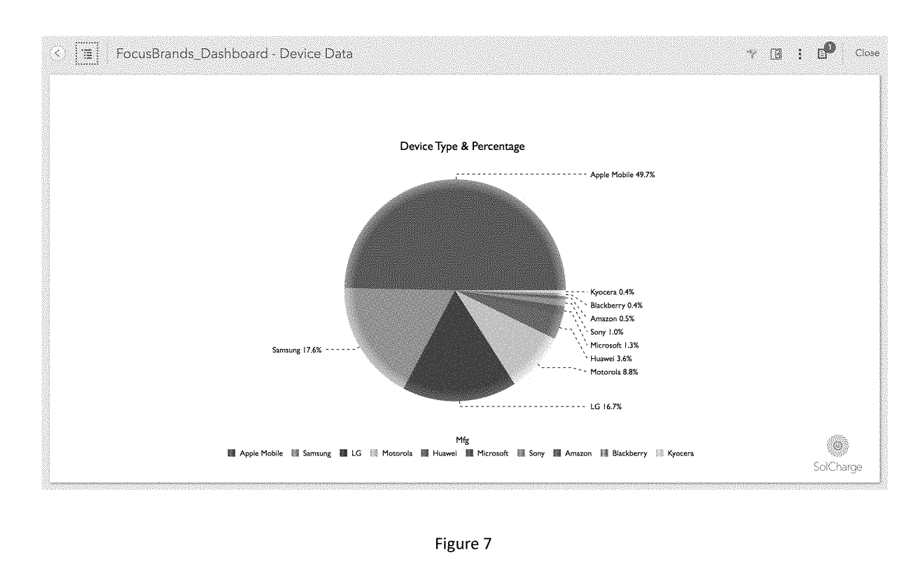

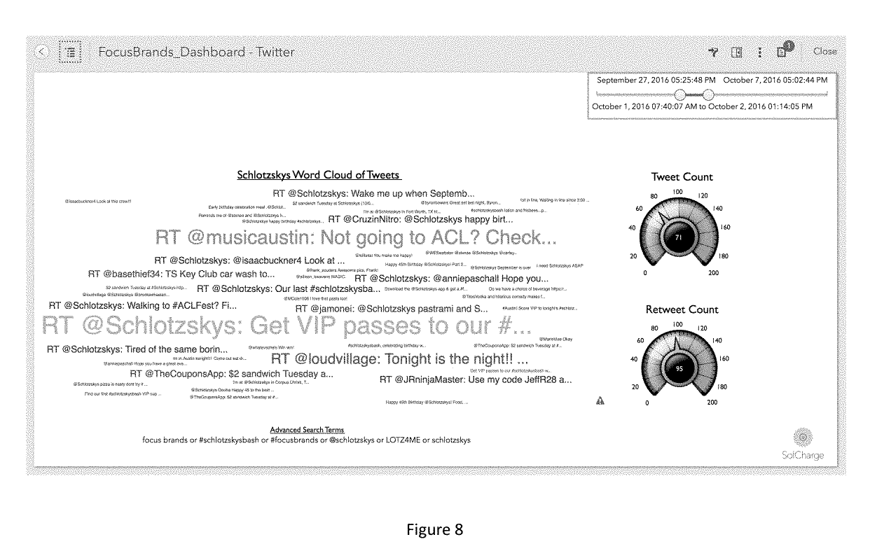

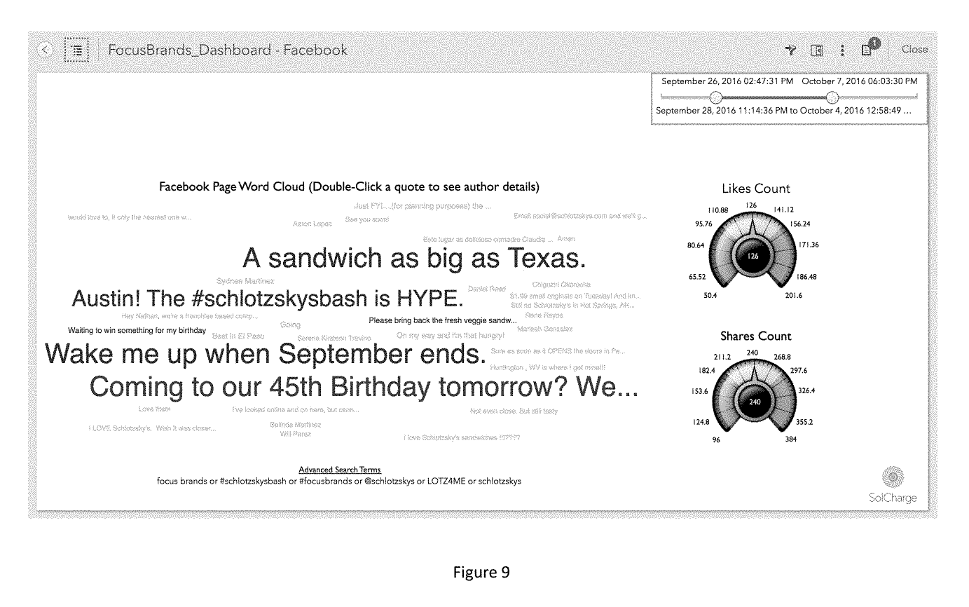

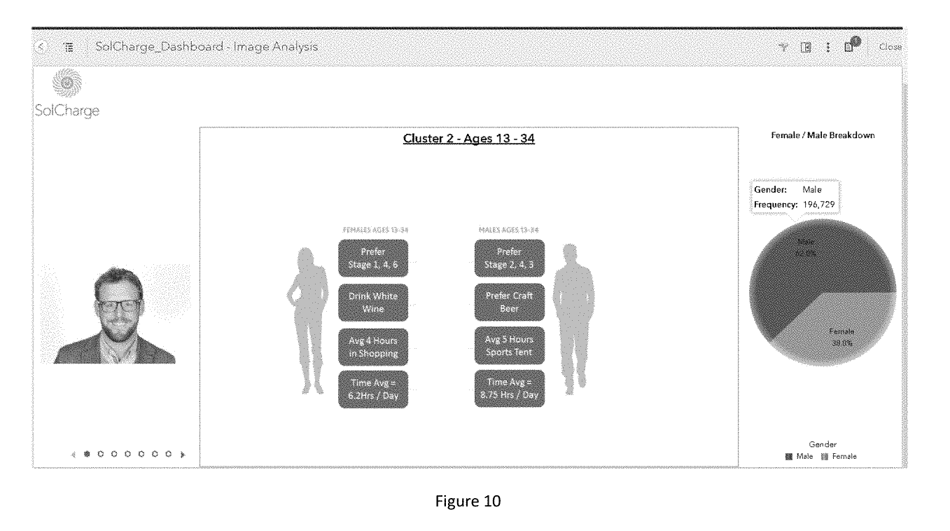

Referring to FIGS. 4 through 10, screen shots of various exemplary reports that can be generated are provided to further explain the features and benefits of this system.

What is claimed is:

1. A method of generating event data and analytics using a portable computing device comprising:
offering event participants to sign-in to access to a service;
providing the service to event participants that sign-in;
gathering data about the event participants that sign-in;
analyzing the gathered data about event participants that sign-in;
generating offers and presenting such offers to the event participants that sign-in.
